(19) United States
(12) Patent Application Publication
(10) Pub. No.: US 2014/0354091 A1
(43) Pub. Date: Dec. 4, 2014

(54) ROTOR FOR ROTARY ELECTRIC MACHINE, AND ROTARY ELECTRIC MACHINE PROVIDED WITH THE ROTOR

(71) Applicant: Eiji Yamada, Owariasahi-shi (JP)

(72) Inventor: Eiji Yamada, Owariasahi-shi (JP)

(73) Assignee: TOYOTA JIDOSHA KABUSHIKI KAISHA, Toyota-shi (JP)

(21) Appl. No.: 14/360,811

(22) PCT Filed: Nov. 28, 2011
(86) PCT No.: PCT/JP2011/077371

§ 371 Date: May 27, 2014

(51) Int. Cl. H02K 11/04; H02K 9/19

(52) U.S. Cl. CPC H02K 11/044; H02K 9/19
USPC 310/54; 310/71

(57) ABSTRACT

In a rotor for a rotary electric machine including an electronic device, such as a diode, around which a coil is wound and which is connected to the coil via a lead wire, poor connection between the coil and the electronic device caused by a centrifugal force is prevented. A rotary electric machine includes: a shaft that is rotatably supported; a rotor core that is fixed to the shaft and around which the coil is wound; and the electronic device that is provided non-parallel to the shaft so as to rotate together with the rotor core, that has a main body having a rectifying function and a terminal section electrically connected to the main body, and in which the lead wire extending from the coil is connected to the terminal section. A connection section between the lead wire and the terminal section of the electronic device is provided on an inner diameter side of the main body of the electronic device in a radial direction of the rotor core.

### TECHNICAL FIELD

The present invention relates to a rotor for a rotary electric machine around which a coil is wound and to a rotary electric machine provided with the rotor.

### BACKGROUND ART

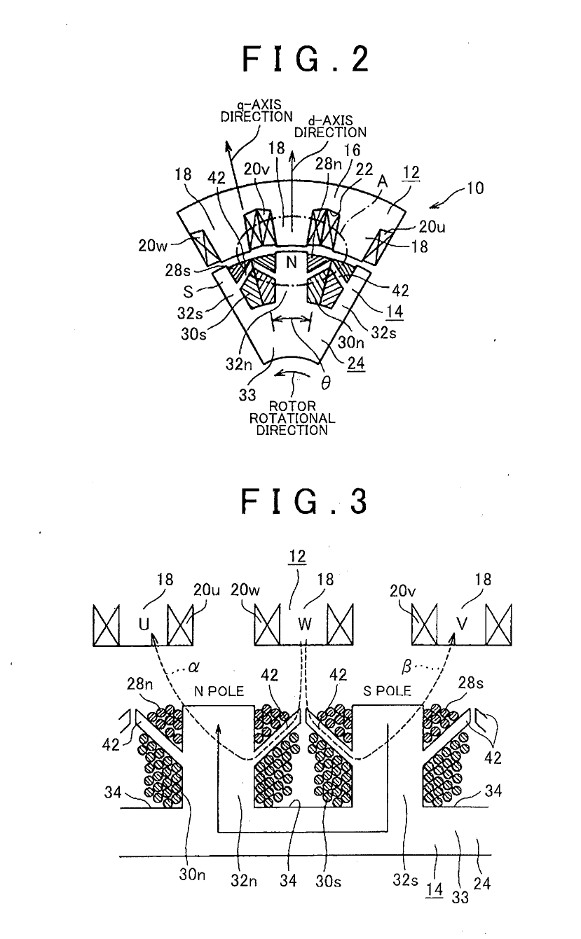

Conventionally, Japanese Utility Model Application Publication No. 5-29275 (JP 5-29275 U) (Patent Document 1) discloses a brushless generator with a built-in exciter in which an armature of a main exciter and a rotor and a rectifier of a sub-exciter are attached to a cylindrical holder, and the holder is then attached to a rotational shaft, so as to allow the armature, the rotor, and the rectifier to be collectively attached to the rotational shaft. FIG. 2 and the like of the Document show that the rectifier (7) is attached parallel to the rotational shaft in this generator.

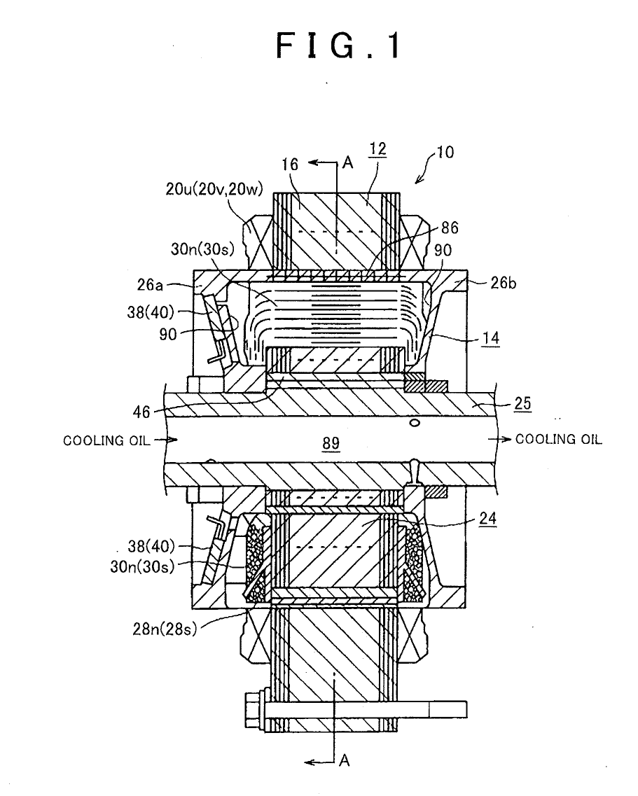

In addition, Japanese Patent Application Publication No. 2005-328617 (JP 2005-328617 A) (Patent Document 2) discloses a synchronous generator of capacitor compensation type that includes: a stator in which an output winding and a capacitor excitation winding are wound around a stator core; and a rotor in which a field winding is wound around a rotor core via a bobbin. Also, in this generator, with reference to the paragraph 0013 and FIGS. 1 to 3 of the Document, it is also described that a diode (I)) is arranged such that a plate surface thereof is directed parallel to an axis of the rotor.

### PRIOR ART DOCUMENTS

### Patent Documents

Patent Document 1: Japanese Utility Model Application Publication No. 5-29275 (JP 5-29275 U)

Patent Document 2: Japanese Patent Application Publication No. 2005-328617 (JP 2005-328617 A)

### SUMMARY OF THE INVENTION

### Problem to be Solved by the Invention

In both of the generators described in Patent Documents 1 and 2, the rectifier or the diode is attached to the rotor in a state parallel to the rotational shaft. In other words, a longest side is parallel to the rotational shaft. In connection with this, an axial length of a rotary electric machine that includes a stator and a rotor provided with a diode is preferably reduced when considering mountability to a vehicle and the like. Accordingly, it is considered to arrange the diode in a non-parallel manner to the rotational shaft.

However, this causes variations in a distance from a center of rotation according to portions of the diode, and a centrifugal force acting on the each portion thereby varies in a rotational shaft direction. Accordingly, this may lead to occurrence of a defect such as failure unless positions of the diode, a lead wire of a coil connected thereto, and the like are appropriately set.

An object of the present invention is to suppress occurrence of poor connection between a coil and an electronic device caused by action of a centrifugal force in a rotor for a rotary electric machine that includes an electronic device, such as a diode, around which the coil is wound and that is connected to the coil via a lead wire.

### Means for Solving the Problem

A rotor for a rotary electric machine according to the present invention includes: a shaft that is rotatably supported; a rotor core that is fixed to the shaft and around which a coil is wound; and an electronic device that is provided non-parallel to the shaft so as to rotate together with the rotor core, that has a main body having a rectifying function and a terminal section electrically connected to the main body, and in which a lead wire extending from the coil is connected to the terminal section. A connecting section between the terminal section of the electronic device and the lead wire is provided on an inner diameter side of the main body of the electronic device in regard to a radial direction of the rotor core. Here, it is intended that the “inner diameter side of the main body” includes a case where the connecting section is positioned on the inner diameter side of the main body and also includes a case where the connecting section is positioned on the inner diameter side of the center in the radial direction of the main body itself when the connecting section is positioned to overlap with the main body in the radial direction.

In the rotor for a rotary electric machine according to the present invention, the terminal section of the electronic device may be a terminal wire that extends from the main body to the inside in the radial direction, and the connecting section with the lead wire may be connected on the inner diameter side of the main body of the electronic device.

In addition, in the rotor for a rotary electric machine according to the present invention, the lead wire of the coil may be drawn from a coil end to the proximity of the shaft on the inside in the radial direction and then drawn to the electronic device side in an axial direction.

In this case, the lead wire that is drawn to the electronic device side in the axial direction may integrally be fixed to the shaft together with the connecting section with the terminal section of the electronic device.

Furthermore, in the rotor for a rotary electric machine according to the present invention, the connecting section between the terminal wire of the electronic device and the lead wire of the coil may be connected in a line contact state or a surface contact state, and the contacting section may be non-parallel to the shaft.

Moreover, in the rotor for a rotary electric machine according to the present invention, the plural electronic devices may be provided at intervals in a circumferential direction on an axial end surface of the rotor, and a refrigerant discharge port for discharging a liquid refrigerant that is supplied from a refrigerant flow passage in the shaft via a refrigerant supply passage may be provided between the electronic devices in regard to the circumferential direction.

In this case, the electronic device may be provided in an end plate that constitutes the axial end surface of the rotor, the refrigerant supply passage may be configured by a first refrigerant supply passage that is formed in the shaft and a second refrigerant supply passage that is formed in the end plate, and the refrigerant discharge port may be formed on a surface of the end plate that is an end of the second refrigerant supply passage.

Also, in this case, the electronic device may be provided in the end plate that constitutes the axial end surface of the rotor, the refrigerant supply passage may be formed in the shaft to supply the liquid refrigerant from the refrigerant flow passage to the outside of the shaft, and the refrigerant discharge port may be formed on a surface of the shaft that is an end of the refrigerant supply passage.

Furthermore, in these cases, a surface of the end plate to which the liquid refrigerant discharged from the refrigerant discharge port is supplied may be inclined to the outside in the axial direction with respect to the radial direction.

A rotary electric machine as another aspect of the present invention includes: a rotor for a rotary electric machine that has one of the above configurations; and a stator that is disposed to face the rotor to make a rotating magnetic field act on the rotor.

### Effect of the Invention

According to the rotor for a rotary electric machine and the rotary electric machine provided with the rotor according to the present invention, since the connecting section between the terminal section of the electronic device and the lead wire that extends from the coil wound around the rotor core is provided on the inner diameter side of the main body of the electronic device, the connecting section can be arranged on the further inner diameter side of the rotor. Thus, it is possible to suppress action of a large centrifugal force on the connecting section, which is caused by high-speed rotation of the rotor, and consequently, a defect such as peeling of the connecting section by the centrifugal force can be less likely to occur.

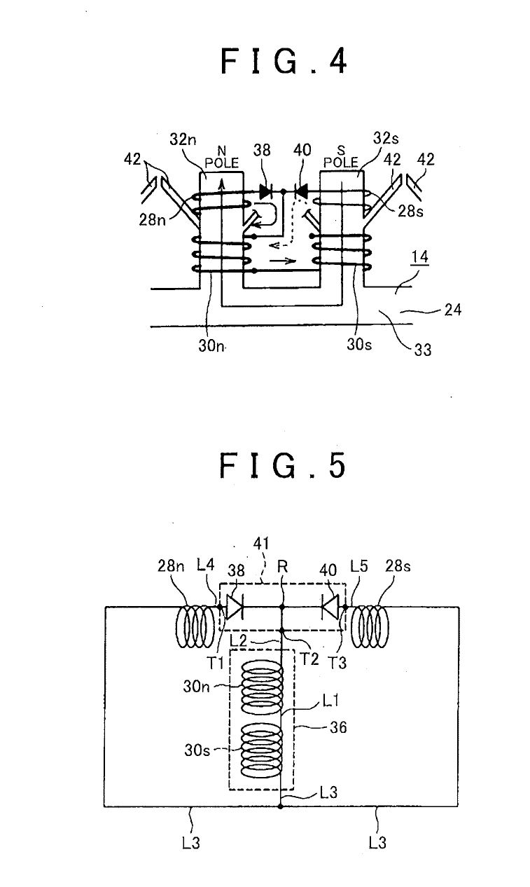

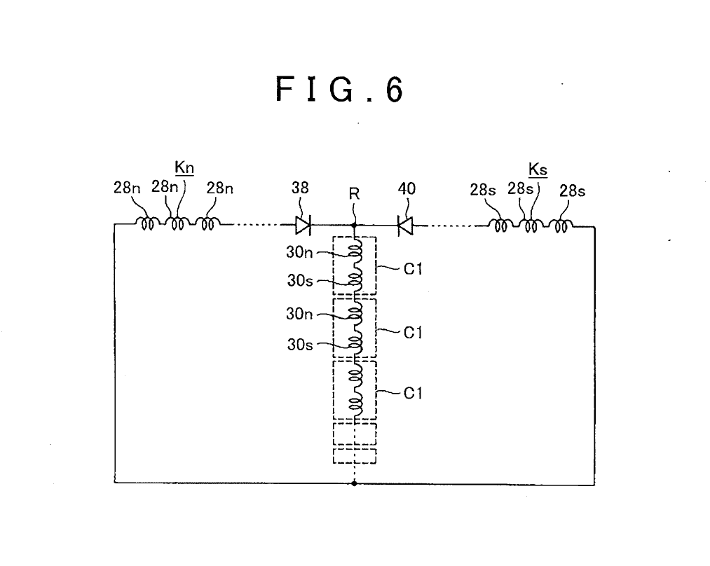

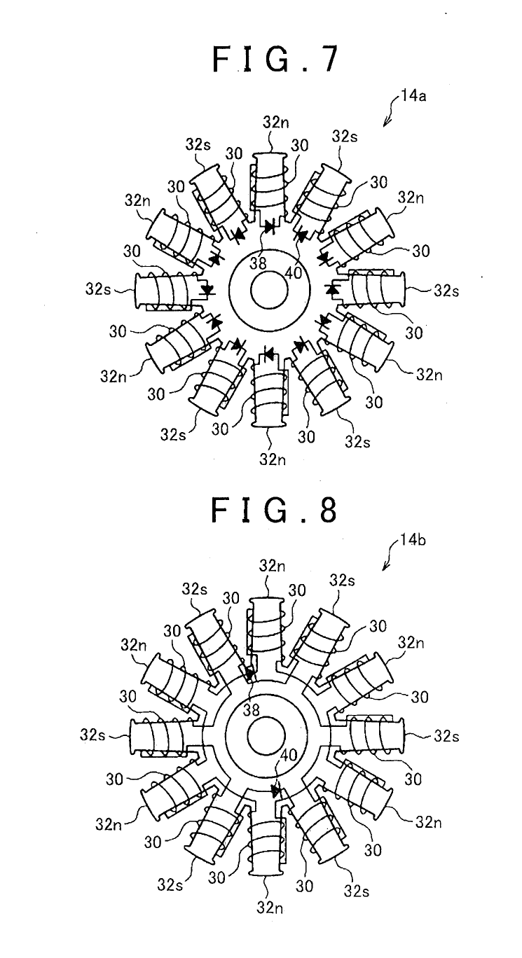

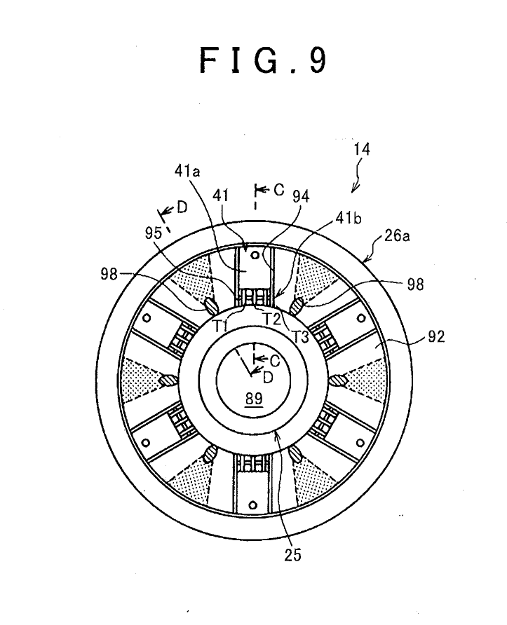

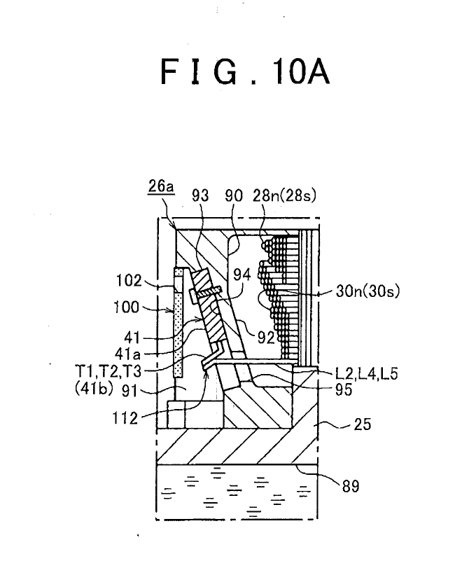

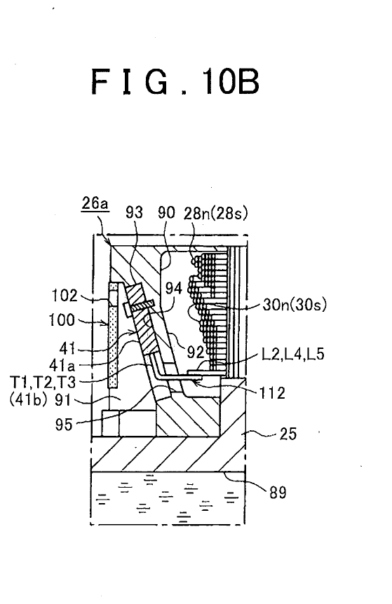

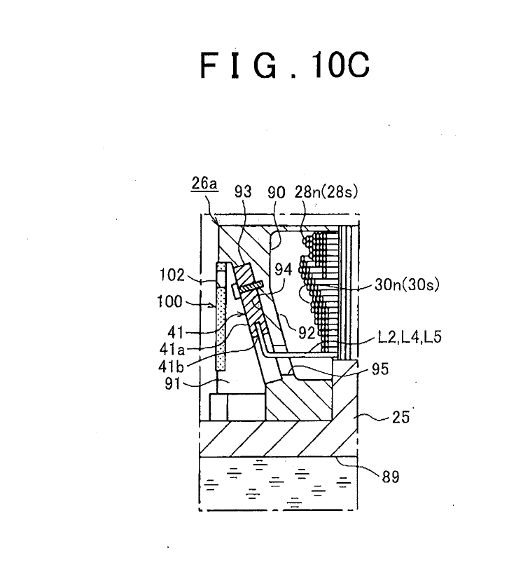

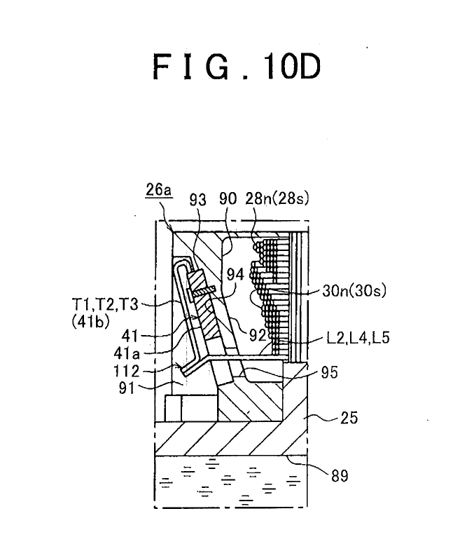

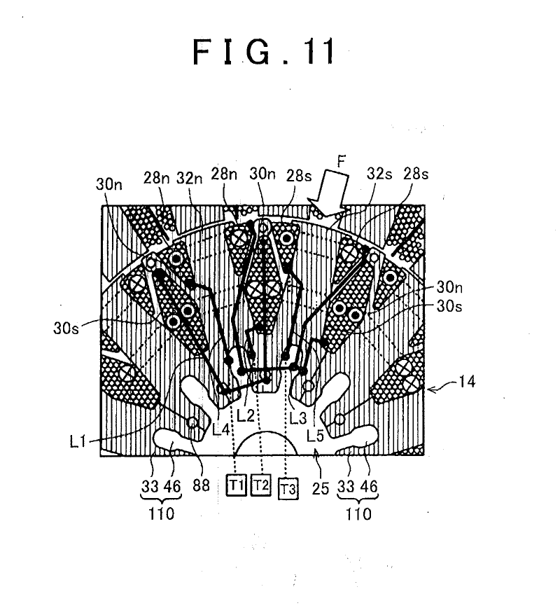

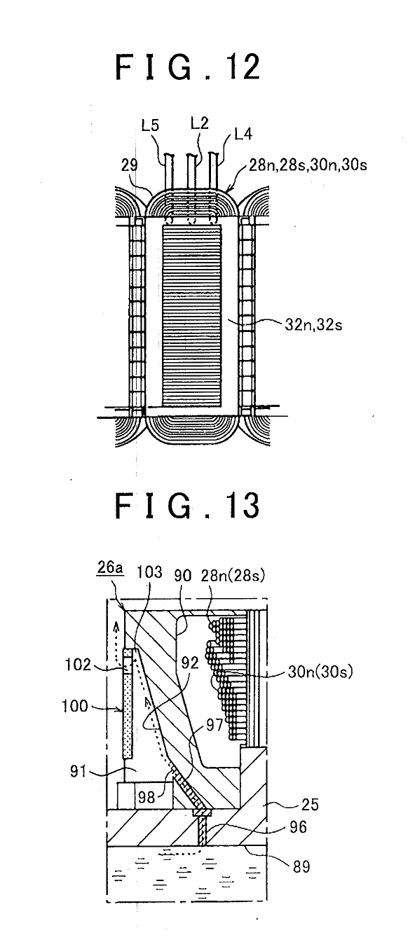

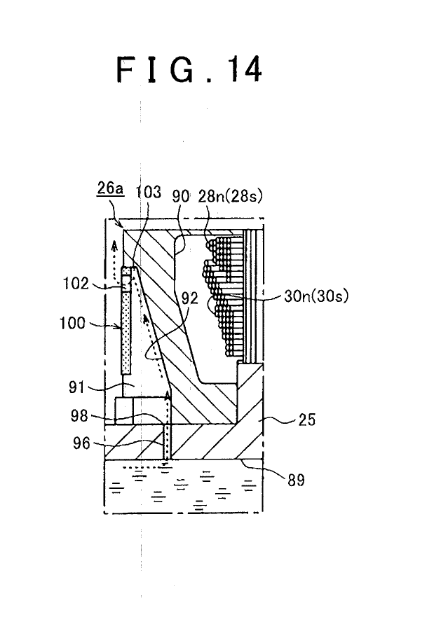

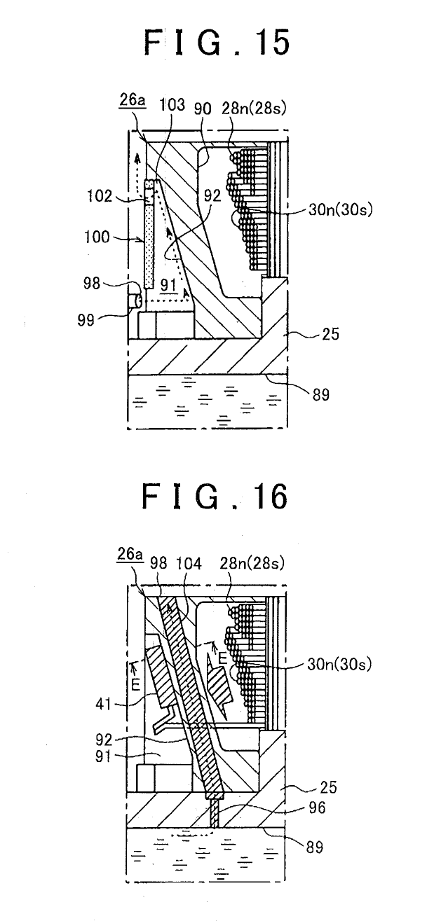

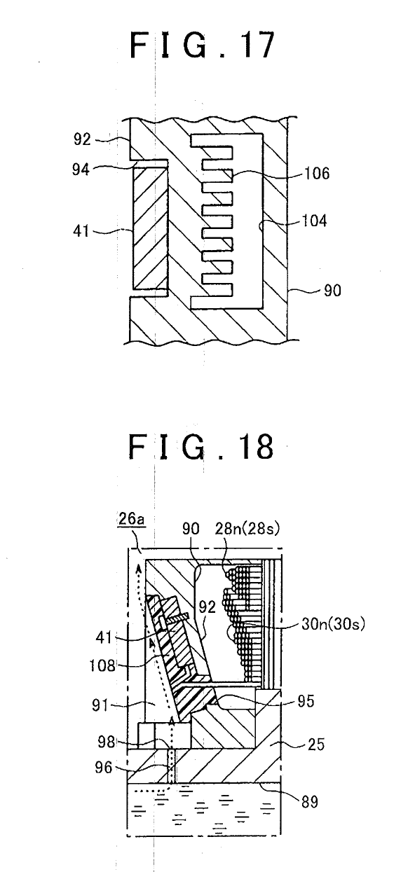

### BRIEF DESCRIPTION OF THE DRAWINGS

[FIG. 1] FIG. 1 is a cross-sectional view for showing a rotary electric machine according to an embodiment of the present invention.

[FIG. 2] FIG. 2 is a cross-sectional view for schematically showing portions of a rotor and a stator in a circumferential direction in the rotary electric machine of this embodiment.

[FIG 3] FIG. 3 is a schematic diagram for showing a situation where a magnetic flux, which is generated by an induced current flowing through rotor coils, flows through the rotor in the rotary electric machine of this embodiment.

[FIG. 4] FIG. 4 is a view that corresponds to FIG. 3 and shows a state that diodes are connected to the rotor coils.

[FIG 5] FIG. 5 is a view for showing an equivalent circuit of a connection circuit of the plural coils that are wound around two adjacent salient poles in the circumferential direction of the rotor in this embodiment.

[FIG 6] FIG. 6 is a view that corresponds to FIG. 5 and shows an example in which the number of the diodes that are connected to the rotor coils is reduced.

[FIG 7] FIG. 7 is a view for showing a modified example in which the diode is connected to each of the rotor coils wound around the salient poles of the rotor.

[FIG 8] FIG. 8 is a view that corresponds to FIG. 7 and shows an example in which the number of the diodes connected to the rotor coils is reduced.

[FIG. 9] FIG. 9 is a view of an axial end surface of the rotor.

[FIG. 10A] FIG. 10A is a cross-sectional view taken along the line C-C in FIG. 9.

[FIG. 10B] FIG. 10B is a view that corresponds to FIG. 10A and shows another example in which a terminal wire of the diode extends toward the coil.

[FIG. 10C] FIG. 10C is a view that corresponds to FIG. 10A and shows yet another example in which a lead wire extending from the coil is inserted in a terminal section of the diode.

[FIG. 10D] FIG. 10D is a view that corresponds to FIG. 10A and shows further another example in which the terminal wire of the diode drawn to an outer diameter side is folded back to an inner diameter side and then connected to the lead wire of the coil.

[FIG. 11] FIG. 11 is a view for showing connection states of the induction coils and the common coils, which are wound around the rotor core, and a connection state between the each coil and the diode, together a partial cross section of the rotor.

[FIG. 12] FIG. 12 is a view that is seen from an arrow F direction in FIG. 11 (that is, the outside in a radial direction).

[FIG. 13] FIG. 13 is a cross-sectional view taken along the fine D-D in FIG. 9.

[FIG. 14] FIG. 14 is a view that corresponds to FIG. 13 and shows another example in which a refrigerant discharge port is formed in a shaft.

[FIG. 15] FIG. 15 is a view that corresponds to FIG. 13 and shows yet another example in which the refrigerant discharge port is provided on the outside of the rotor.

[FIG. 16] FIG. 16 is a view that corresponds to FIG. 13 and shows further another example in which a refrigerant passage is formed in an end plate.

[FIG. 17] FIG. 17 is a cross-sectional view taken along the line E-E in FIG. 16.

[FIG. 18] FIG. 18 is a view that corresponds to FIG. 13 and shows an example in which the electronic device is covered with a molding resin and a refrigerant is supplied thereon.

### MODES FOR CARRYING OUT THE INVENTION

An embodiment of the present invention will hereinafter be described with reference to drawings. FIGS. 1 to 5 show the embodiment of the present invention. FIG. 1 is a schematic cross-sectional view for showing portion of a rotary electric machine that includes a rotor for a rotary electric machine according to this embodiment. As shown in FIG. 1, a rotary electric machine 10 functions as an electric motor or a generator, and includes a cylindrical stator 12 that is fixed to a casing (not shown) and a rotor 14 that is disposed on the inside in a radial direction to face the stator 12 with a specified space therefrom and that is rotatable with respect to the stator 12. Here, the “radial direction” indicates a radiation direction that is orthogonal to a rotation center axis of the rotor 14 (a same meaning applies to the “radial direction” in the entire description and the claims unless otherwise noted).

The stator 12 includes a stator core 16 made of a magnetic material and multi-phase (three-phase of a U phase, a V phase, and a W phase, for example) stator coils 20u, 20v, 20w that are disposed in the stator core 16. The rotor 14 includes a rotor core 24 made of a magnetic material, a shaft 25 that is inserted in a central section of the rotor core 24 to be fixedly fitted, and two end plates 26a, 26b arranged on both axial sides of the rotor core 24.

The rotor 14 also includes: an N pole induction coil 28n, an S pole induction coil 28s, an N pole common coil 30n, and an S pole common coil 30s that are plural rotor coils disposed in the rotor core 24; a first diode 38 that is connected to the N pole induction coil 28n; and a second diode 40 that is connected to the S pole induction coil 28s.

First, a basic configuration of the rotary electric machine 10 will be described by using FIGS. 2 to 5. FIG. 2 is a cross-sectional view for schematically showing portions of the rotor and the stator in a circumferential direction in the rotary electric machine of this embodiment. FIG. 3 is a schematic diagram for showing a situation where a magnetic flux, which is generated by an induced current flowing through the rotor coils, flows through the rotor in the rotary electric machine of this embodiment. FIG. 4 is a view that corresponds to FIG. 3 and shows a state that the diodes are connected to the rotor coils.

As shown in FIG. 2, the stator 12 includes the stator core 16. Plural teeth 18 that protrude to the inside in the radial direction (that is, toward the rotor 14) are arranged at plural positions in the circumferential direction in an inner peripheral surface of the stator core 16, and a slot 22 is formed between each pair of the adjacent teeth 18. The stator core 16 is formed of a magnetic material such as a laminated body of metallic sheets, an example of the metallic sheet including a magnetic steel sheet having a magnetic property such as a silicon steel sheet. The plural teeth 18 are aligned at intervals with each other along the circumferential direction around the rotation center axis that is the rotational axis of the rotor 14. Here, the “circumferential direction” indicates a direction along a circle that is drawn with the rotation center axis of the rotor 14 as a center (a same meaning applies to the “circumferential direction” in the entire description and the claims unless otherwise noted).

Each of the stator coils 20u, 20v, 20w for respective phases penetrates the slot 22 and is wound around the tooth 18 of the stator core 16 by short-pitched and concentrated winding. Magnetic poles are configured by winding the stator coils 20u, 20v, 20w around the teeth 18 just as described. Then, when a multi-phase alternating current flows through the multi-phase stator coils 20u, 20v, 20w, the teeth 18 that are aligned in the circumferential direction are magnetized, and a rotating magnetic field that rotates in the circumferential direction can thereby be generated in the stator 12.

A configuration of each of the stator coils 20u, 20v, 20w is not limited to that in which the coil is wound around the tooth 18 of the stator 12 just as described. For example, the multi-phase stator coils are toroidally wound at plural positions in the circumferential direction of an annular portion of the stator core 16 that is separated from the teeth 18, and the rotating magnetic field can thereby be generated in the stator 12.

The rotating magnetic field formed in the tooth 18 acts on the rotor 14 from a tip surface thereof. In an example shown in FIG. 2, one pole pair is configured by the three teeth 18, around which the three-phase (the U phase, the V phase, and the W phase) stator coils 20u, 20v, 20w are wound.

Meanwhile, the rotor 14 includes the rotor core 24 made of the magnetic material as well as the N pole induction coil 28n, the N pole common coil 30n, the S pole induction coil 28s, and the S pole common coil 30s that are the plural rotor coils. The rotor core 24 has an N pole forming salient pole 32n and an S pole forming salient pole 32s that are plural magnetic pole sections provided in plural positions in the circumferential direction of an outer peripheral surface to protrude toward the outside in the radial direction (that is, toward the stator 12) and that are main salient poles.

The N pole forming salient pole 32n and the S pole forming salient pole 32s are alternately arranged at intervals with each other along the circumferential direction of the rotor core 24, and each of the salient poles 32n, 32s face the stator 12. A rotor yoke 33 and the plural salient poles 32n, 32s, which form an annular portion of the rotor core 24, can integrally be configured by annularly connecting plural rotor core elements as a laminated body in which plural metallic sheets made of the magnetic material are laminated. A detailed description on this will be made below. The N pole forming salient pole 32n and the S pole forming salient pole 32s are in a same shape and size with each other.

More specifically, the N pole common coil 30n and the N pole induction coil 28n as the two N pole rotor coils are wound by the concentrated winding around each of the N pole forming salient poles 32n that are alternately provided in the circumferential direction of the rotor 14. In addition, in the rotor 14, the S pole common coil 30s and the S pole induction coil 28s as the two S pole rotor coils are wound by the concentrated winding around each of the S pole forming salient poles 32s that are different salient poles from the N pole forming salient pole 32n, adjacent thereto, and alternately provided in the circumferential direction. In regard to the radial direction of the rotor 14, each of the common coils 30n, 30s is an inner coil while each of the induction coils 28n, 28s is an outer coil.

As shown in FIG. 3, the rotor 14 has a slot 34 that is formed between the adjacent salient poles 32n, 32s in the circumferential direction. In other words, in rotor core 24, the plural slots 34 are formed at intervals with each other in the circumferential direction around the rotational axis of the rotor 14. In addition, the rotor core 24 is fixedly fitted to the outside in the radial direction of the shaft 25 as the rotational axis (see FIG 1).

The each N pole induction coil 28n is wound around a tip side of the each N pole forming salient pole 32n from the N pole common coil 30n, that is, a side close to the stator 12. The each S pole induction coil 28s is wound around a tip side of the each S pole forming salient pole 32s from the S pole common coil 30s, that is, a side close to the stator 12.

As shown in FIG. 3, the induction coils 28n, 28s and the common coils 30n, 30s that are respectively wound around the salient poles 32n, 32s can be arranged by regular winding, in which solenoids that are provided along a lengthwise direction (a vertical direction in FIG. 3) near the salient pole 32n (or 32s) are aligned in plural layers in the circumferential direction (a horizontal direction in FIG. 3) of the salient pole 32n (or 32s). In addition, the induction coils 28n, 28s that are respectively wound around the tip sides of the salient poles 32n, 32s may respectively be wound around the salient poles 32n, 32s for plural times, that is, plural turns in spiral shapes.

As shown in FIG. 4 and FIG. 5, when the two adjacent salient poles 32n, 32s in the circumferential direction of the rotor 14 serve as a pair, one end of the one N pole induction coil 28n, which is wound around the N pole forming salient pole 32n, is connected to one end of the other S pole induction coil 28s, which is wound around the other S pole forming salient pole 32s in the each pair, via the first diode 38 and the second diode 40 as two electronic devices and also as rectifying elements. FIG. 5 shows an equivalent circuit of a connection circuit of the plural coils 28n, 28s, 30n, 30s that are wound around the two adjacent salient poles 32n, 32s in the circumferential direction of the rotor 14 in this embodiment. As shown in FIG. 5, the one end of the N pole induction coil 28n and the one end of the S pole induction coil 28s are connected at a connection point R via the first diode 38 and the second diode 40 whose forward directions are opposite from each other. In this embodiment, as will be described below, a diode element 41 in which the first and second diodes 38, 40 are integrated by a resin mold package is used.

In this embodiment, a case where the electronic devices, which are connected to the coils 28n, 28s, 30n, 30s wound around the rotor core 24, are the diodes is described; however, the electronic devices are not limited thereto. For the electronic device described above, a rectifier of another type (such as a thyristor or a transistor, for example) that has a function to rectify the current flowing through the coils may be used, or an electronic device such as a resistor or a capacitor may be used in conjunction with the rectifier such as the diode.

As shown in FIG. 4 and FIG. 5, one end of the N pole common coil 30n, which is wound around the N pole forming salient pole 32n, is connected to one end of the S pole common coil 30s, which is wound around the S pole forming salient pole 32s, in the each pair. The N pole common coil 30n and the S pole common coil 30s are connected to each other in series, thereby forming a common coil pair 36. Furthermore, another end of the N pole common coil 30n is connected to the connection point R while another end of the S pole common coil 30s is connected to ends of the N pole induction coil 28n and the S pole induction coil 28s that are opposite from the ends connected to the connection point R. In addition, a winding center axis of each of the induction coils 28n, 28s and each of the common coils 30n, 30s corresponds to the radial direction of the rotor 14 (FIG. 2). Each of the induction coils 28n, 28s and each of the common coils 30n, 30s can also be wound around the corresponding salient pole 32n (or 32s) via an insulator (not shown) that is formed of a resin or the like and has an electric, insulating property.

In such a configuration, as will be described below, since the rectified current flows through the N pole induction coil 28n, the S pole induction coil 28s, the N pole common coil 30n, and the S pole common coil 30s, each of the salient poles 32n, 32s is magnetized and thus functions as the magnetic pole section. Returning to FIG. 3, the stator 12 generates the rotating magnetic field when the alternating current flows through the stator coils 20u, 20v, 20w, and this rotating magnetic field includes not only a magnetic field of a fundamental wave component but also a magnetic field of a harmonic component that is in a higher order than a fundamental wave.

More specifically, due to arrangement of the stator coils 20u, 20v, 20w of the respective phases and a shape of the stator core l 6 defined by the teeth 18 and the slots 22 (see FIG. 2), distribution of a magnetomotive force that generates the rotating magnetic field in the stator 12 does not become sinusoidal distribution (that only includes the fundamental wave) but includes the harmonic component. Particularly, since the stator coils 20u, 20v, 20w of the respective phases do not overlap each other by the concentrated winding, an amplitude level of the harmonic component that is generated in the magnetomotive force distribution of the stator 12 is increased. For example, when the stator coils 20u, 20v, 20w are wound by the three-phase concentrated winding, the amplitude levels of a tertiary time component that is a secondary space component of an input electrical frequency as the harmonic .component is increased. The harmonic component that is generated in the magnetomotive force due to the arrangement of the stator coils 20u, 20v, 20w and the shape of the stator core 16, just as described, is referred to as a space harmonic.

When the rotating magnetic field including this space harmonic component acts on the rotor 14 from the stator 12, a variation in the magnetic flux of the space harmonic causes a variation in leakage magnetic flux that is leaked to a space between the salient poles 32n, 32s of the rotor 14. Accordingly, of each of the induction coils 28n, 28s shown in FIG. 3, an induced electromotive force is generated in at least one of the induction coils 28n, 28s.

The induction coils 28n, 28s that are on the tip sides of the respective salient poles 32n, 32s and thus are close to the stator 12 mainly have a function to generate the induced current. Meanwhile, the common coils 30n, 30s that are away from the stator 12 mainly have a function to magnetize the salient poles 32n, 32s. In addition, as can be understood from the equivalent circuit in FIG. 5, a sum of the currents flowing through the induction coils 28n, 28s, which are respectively wound around the adjacent salient poles 32n, 32s (see FIG. 2 to FIG. 4), is a current flowing through each of the common coils 30n, 30s. Since the adjacent common coils 30n, 30s are connected in series, a same effect as that obtained by increasing the number of turns thereof can be obtained, and the intensity of the current flowing through each of the common coils 30n, 30s can be reduced while the magnetic flux flowing through each of the salient poles 32n, 32s is maintained.

When the induced electromotive force is generated in each of the induction coils 28n, 28s, a direct current that corresponds to a rectifying direction of the diodes 38, 40 flows through the N pole induction coil 28n, the S pole induction coil 28s, the N pole common coil 30n, and the S pole common coil 30s, and the salient poles 32n, 32s, around which the common coils 30n, 30s are respectively wound, are magnetized. Thus, these salient poles 32n, 32s each functions as the magnetic pole section as an electromagnet whose magnetic pole is fixed.

Since a winding direction of the N pole induction coil 28n and the N pole common coil 30n is opposite from a winding direction of the S pole induction coil 28s and the S pole common coil 30s, which are adjacent to the N pole induction coil 28n and the N pole common coil 30n in the circumferential direction as shown in FIG. 4, magnetization directions of the adjacent salient poles 32n, 32s in the circumferential direction are opposite from each other. In the illustrated example, an N pole is generated at the tip of the salient pole 32n around which the N pole induction coil 28n and the N pole common coil 30n are wound, and an S pole is generated at the tip of the salient pole 32s around which the S pole induction coil 28s and the S pole common coil 30s are wound. Thus, the N pole and the S pole are alternately arranged in the circumferential direction of the rotor 14. In other words, the rotor 14 is configured that the N pole and the S pole are alternately formed in the circumferential direction by interlinkage of the harmonic components that are included in the magnetic field generated in the stator 12.

In the rotary electric machine 10 that includes such a rotor 14 (see FIG. 2), when the three-phase alternating current flows through the three-phase stator coils 20u, 20v, 20w, the rotating magnetic field (the fundamental wave component) formed in the teeth 18 (see FIG. 2) acts on the rotor 14, and, corresponding to this, the salient poles 32n, 32s are attracted to the rotating magnetic field of the teeth 18 so as to reduce magnetic resistance of the rotor 14. Accordingly, torque (reluctance torque) acts on the rotor 14.

In addition, when the rotating magnetic field that is formed in the teeth 18 and includes a space harmonic component is interlinked with each of the induction coils 28n, 28s of the rotor 14, the induced electromotive force is generated in each of the induction coils 28n, 28s by a variation in the magnetic flux of a frequency that is different from a rotational frequency of the rotor 14 (the fundamental wave component of the rotating magnetic field) attributed to the space harmonic component. The current that flows through each of the induction coils 28n, 28s in connection with generation of the induced electromotive force is rectified by each of the diodes 38, 40 and thereby flows in one direction (as the direct current).

Then, the direct current that is rectified by each of the diodes 38, 40 flows through the induction coils 28n, 28s and the common coils 30n, 30s, and, corresponding to this, the salient poles 32n, 32s are magnetized. Accordingly, each of the salient poles 32n, 32s functions as the magnet whose magnetic pole is fixed (to either one of the N pole and the S pole). As described above, since the rectifying directions of the currents flowing through the induction coils 28n, 28s oppose each other by the diodes 38, 40, the N pole and the S pole are alternately arranged in the circumferential direction in the magnets generated in the salient poles 32n, 32s.

Then, the magnetic field of each of the salient poles 32n, 32s (the magnets with the fixed magnetic poles) interacts with the rotating magnetic field (the fundamental wave component) generated by the stator 12 to cause attraction and repulsion. The electromagnetic interaction (the attraction and the repulsion) between the rotating magnetic field (the fundamental wave component) generated by the stator 12 and the magnetic fields of the salient poles 32n, 32s (the magnets) can also exert the torque (the torque corresponding to magnet torque) on the rotor 14, and the rotor 14 is synchronized with the rotating magnetic field (the fundamental wave component) generated by the stator 12 to be rotationally driven. As it has been described so far, the rotary electric machine 10 can function as a motor in which the rotor 14 generates power (mechanical power) by using the current supplied to the stator coils 20u, 20v, 20w.

In this embodiment, a case has been described where the two adjacent salient poles 32n, 32s are paired and the induction coils 28n, 28s that are respectively wound around the two salient poles 32n, 32s are connected to each other via the two diodes 38, 40 in the each pair. Thus, the two diodes 38, 40 are necessary for the two salient poles 32n, 32s. , Meanwhile, it is also possible to connect all of the coils 28n, 28s, 30n, 30s that are wound around all of the salient poles 32n, 32s of the rotor 14 and to use only the two diodes 38, 40. FIG. 6 is a view that corresponds to FIG. 5 and shows a modified example in which the number of the diodes connected to the rotor coils is reduced.

In the modified example shown in FIG. 6, the N pole induction coils 28n that are wound around the tip sides of all of the N pole forming salient poles 32n (see FIG. 3) are connected in series to form an N pole induction coil group Kn, and the S pole induction coils 28s that are wound around the tip sides of all of the S pole forming salient poles 32s (see FIG. 3) are connected in series to form an S pole induction coil group Ks, the N pole forming salient poles 32n being the salient poles that are alternately provided in the circumferential direction of the rotor and the S pole forming salient poles 32s being adjacent to the N pole forming salient poles 32n in the rotor in the above-mentioned configuration shown in FIG. 3, FIG. 4, and the like. One ends of the N pole induction coil group Ku and the S pole induction coil group Ks are connected at the connection point R via the first diode 38 and the second diode 40 whose forward directions are opposite from each other.

In addition, when two of the N pole forming salient pole 32n and the S pole forming salient pole 32s (see FIG. 3) that are adjacent in the circumferential direction of the rotor are paired, the N pole common coil 30n and the S pole common coil 30s in the each pair are connected in series to form a common coil group C1, and all of the common coil groups C1 for all of the salient poles 32n, 32s are connected in series. Furthermore, of the common coil groups C1 connected in series, one end of the N pole common coil 30n in the common coil group C1 at one end is connected to the connection point R, and one end of the S pole common coil 30s in another common coil group C1 at another end is connected to the other ends of the N pole induction coil group Kn and the S pole induction coil group Ks that are opposite from the connection point R. In such a configuration that is different from the configuration shown in FIG. 4 and FIG. 5, the total number of the diodes provided in the rotor can be reduced to the two of the first diode 38 and the second diode 40, and it is thereby possible to reduce cost and man-hours.

The configuration of the rotor has been described above in which the induction coils 28n, 28s and the common coils 30n, 30s are wound around the N pole forming salient pole 32n and the S pole forming salient pole 32s, and the induction coils 28n, 28s and the common coils 30n, 30s in the adjacent salient poles 32n, 32s in the circumferential direction are connected via the two diodes 38, 40. However, the configuration of the rotary electric machine of the present invention is not limited thereto. For example, as in a rotor 14a that is shown in FIG. 7, a configuration may be adopted in which a coil 30 is independently wound around each of the salient poles 32n, 32s and in which the diode 38 or 40 may be connected to each of the coils 30 in series. In this case, each of the salient poles 32n, 32s may Or may not be provided with an auxiliary salient pole 42 (see FIGS. 3, 4).

Alternatively, as in a rotor 14b that is shown in FIG. 8, and in comparison with the configuration of the rotor shown in FIG. 7, the number of the diodes to be used may be reduced. More specifically, although the rotor 14b is same in a point that the coil 30 is independently wound around each of the N pole forming salient poles 32n and the S pole forming salient poles 32s, the coils 30 that are alternately provided in the circumferential direction may be connected in series and then connected to the one diode 38, and the remaining coils 30 may be connected in series and then connected to the one diode 40 whose forward direction is opposite from the diode 38. Accordingly, the number of the diodes to be used can be reduced from the number corresponding to that of the salient poles 32n, 32s to two.

Furthermore, in the rotors 14a, 14b that are respectively shown in FIG. 7 and FIG. 8, the rotor core 24 may be configured by connecting plural split cores (each of which corresponds to each of the salient poles 32n, 32n) in an annular shape, each of the split core being formed by laminating the magnetic steel sheets. Alternatively, the rotor core 24 may be formed such that the magnetic steel sheets that are punched in the annular shape are laminated, caulked in the axial direction, and then integrally connected by welding or the like. In this case, a circumferential position of the rotor core that is fixed to the shaft can be determined by key engagement, press fitting, interference fit, or the like.

Next, with reference to FIG. 9 to FIG. 18 in addition to FIG. 1, attachment of the diodes to the rotor, connection between the diodes and the coils, and cooling of the diodes will be described.

FIG. 9 is a view of an end plate 26a provided in the rotor 14 that is seen from the outside in the axial direction. FIG. 10A is a cross-sectional view taken along the line C-C in FIG. 9. FIGS. 10B to 10D are views that correspond to FIG. 10A and show other examples, in each of which a connection state between a terminal wire of the diode and a lead wire of the coil differs. FIG. 11 is a view for showing connection states of the induction coils and the common coils, which are wound around the rotor core, and a connection state between the each coil and the diode, together with a partial cross section of the rotor. FIG. 12 is a view that is seen from an arrow F direction in FIG. 11 (that is, the outside in the radial direction). In regard to the axial direction, a side near the rotor core 24 is referred to as the “inside in the axial direction”, and a side away from the rotor core 24 is referred to as the “outside in the axial direction” in the following description, and the same applies to the entire description and the claims of the subject application.

As shown in FIG. 1, the rotor 14 includes: the shaft 25 that is rotatably supported at both end sides (not shown); the rotor core 24 that is fixedly fitted to the periphery of the shaft 25 by caulking, shrink fitting, press fitting, or the like; and the end plates 26a, 26b that are arranged on both sides in the axial direction of the rotor core 24. As described above, the induction coils 28n, 28s and the common coils 30n, 30s are wound around the rotor core 24. The end plates 26a, 26b are provided by being abutted against both ends in the axial direction of the rotor core 24, and constitute ends in the axial direction of the rotor 14 that has a substantially cylindrical shape, except for the shaft 25.

On the inside in the axial direction of each of the end plates 26a, 26b, an inner recess section 90 is formed that avoids a coil end of each of the coils 28n, 28s, 30n, 30s arranged to protrude to the outside from both of the ends in the axial direction of the rotor core 24. In addition, on the outside in the axial direction of each of the end plates 26a, 26b, an outer recess section 91 is formed that encloses a substantially conical space. Each of the end plates 26a, 26b is formed of a non-magnetic material and is abutted against the rotor core 24 at inner ends in the axial direction of an outer peripheral end and an inner peripheral end.

In each of the end plates 26a, 26b, the inner recess section 90 and the outer recess section 91 are divided by an end wall section 92 that is substantially opposed in the axial direction. The end wall section 92 is formed such that it is inclined to the outside in the axial direction as it is located on the outside in the radial direction. In addition, an outer surface of the end wall section 92 constitutes an axial end surface of the rotor 14.

In the rotor 14 of this embodiment, the diode element 41 (the electronic device) that includes the pair of the first and second diodes 38, 40 in an integral manner is attached to the one end plate 26a of the two end plates 26a, 26b. The diode element 41 includes a main body 41a in which the first and second diodes 38, 40 are packaged in the resin mold and a terminal section 41b for connecting each of the diodes 38, 40 to the coils 28n, 28s, 30n, 30s. In this embodiment, the terminal section 41b of the diode element 41 is configured by three terminal wires T1, T2, T3 that extend from the main body 41a.

The diode element 41 is provided on the end plate 26a that rotates together with the rotor core 24 in a non-parallel posture to the shaft 25, that is, in a posture that is not parallel to the shaft 25. Here, the posture of the diode element 41 that is not parallel to the shaft 25 indicates a posture of the main body 41a that is inclined to the axial direction such that the terminal section 41b of the diode element 41 is positioned on the further inner diameter side, and more preferably indicates a posture in which a terminal section arrangement surface of the main body 41a is directed to the shaft 25 side. In this embodiment, the diode element 41 is fixed to an outer surface of the end wall section 92 of the end plate 26a that is formed to be inclined to the outside in the axial direction with respect to the radial direction, and is attached in a posture that the terminal section arrangement surface of the main body 41a is substantially opposed to the shaft 25 or in a posture that the main body 41a in a substantially flat rectangular shape is substantially orthogonal to the axial direction.

In this embodiment, the end wall section 92 of the end plate 26a, to which the diode element 41 is attached, is formed to be inclined to the outside in the axial direction with respect to the radial direction; however, a configuration thereof is not limited thereto. The outer surface of the end wall section 92 may be formed along the radial direction, and the diode element 41 may be attached thereon. In this case, the diode main body 41a of the diode element 41 (see FIG. 10A) is arranged in a posture that is orthogonal to the axial direction.

On the outer surface of the end wall section 92 of the end plate 26a, plural attachment grooves 94 are radially formed at intervals in the circumferential direction, each of the attachment grooves 94 extending in the radial direction and having an abutment wall in an outer periphery thereof An opening 95 for the electrical connection between the diode element 41 and each of the coils 28n, 28s, 30n, 30s is formed on an inner diameter side of the each attachment groove 94, and the inner recess section 90 is communicated with the outer recess section 91 via the opening 95. The opening 95 is a through hole that is formed in the end plate 26a for the electrical connection between the diode element 41 and each of the coils 28n, 28s, 30n, 30s wound around the rotor core 24.

The diode element 41 is fitted and arranged in the attachment groove 94, and is fixed by a method such as screwing, for example, in a state of contacting an abutment wall section 93 on the outside in the radial direction. In this embodiment, the six attachment grooves 94 are formed, and the main body 41a of the diode element 41 is arranged in each of the grooves. Just as described, since the diode element 41 is provided to contact the abutment wall section 93 on the outside in the radial direction, the diode element 41 can securely be held and supported against a centrifugal force that acts during rotation of the rotor 14. In addition, since the terminal wires T1, T2, T3 of the diode element 41 are arranged to be directed to the inner diameter side in this embodiment, a entire outer diameter side surface of the main body 41a of the diode element 41 is abutted against the abutment wall section 93, and thus the diode element 41 can stably be held and supported against the centrifugal force.

In this embodiment, all of the diode elements 41 are attached to the one end plate 26a; however, the configuration thereof is not limited thereto, and some of the diode elements 41 may be attached to the other end plate 26b. More specifically, of the six diode elements 41 shown in FIG. 9, three of them may be attached to the other end plate 26b.

In addition, the first and second diodes 38, 40 that are separately packaged may be used. In this case, the terminal sections (or the terminal wires) of each of the diodes 38, 40 are provided at two positions. Also, in this case, the first diode 38 may be attached to the one end plate 26a while the second diode 40 may be attached to the other end plate 26b, for example.

As described above, the each diode element 41 has the main body 41 a and the terminal section 41b, and the terminal section 41b is configured by the three pin-shaped terminal wires T1, T2, T3 that protrude from the main body 41a of the diode element 41. The diode element 41 is attached to the end plate 26a in the posture that these terminal wires T1, T2,13 are directed to the inner diameter side.

Referring to FIGS. 11, 12, in the rotor 14, the induction coils 28n, 28s are respectively wound around the outer diameter side and the common coils 30n, 30s are respectively wound around the inner diameter side of the pair of the N pole forming salient pole 32n and the S pole forming salient pole 32s that are adjacent to each other in the circumferential direction. The one end of the common coil 30n of the N pole forming salient pole 32n is connected to the one end of the common coil 30s of the S pole forming salient pole 32s via a lead wire L1 (see also FIG. 5).

The lead wire L1 is provided on one side of a coil end 29 that protrudes from both axial end surfaces of the rotor core 24. The lead wire L1 extends from the one end of the common coil 30n to the inside in the radial direction, extends across the circumferential direction in a circular area 110 that includes an outer protruding section 46 of the shaft 25 and the rotor yoke 33, extends to the outside in the radial direction, and is connected to the one end of the common coil 30s.

In the above pair of the salient poles 32n, 32s, the other end of the N pole common coil 30n is connected to the terminal wire T2 of the diode element 41 via a lead wire L2 (see also FIG. 5). The lead wire L2 is also provided on the same coil end 29 side as the lead wire L1. The lead wire L2 is drawn from the other end of the N pole common coil 30n to the circular area 110 on the inner diameter side, is then drawn in the axial direction as shown in FIG. 10A and FIG. 12, passes through the opening 95 of the end plate 26a, and is connected to the terminal wire T2.

In addition, referring to FIG. 11, in the above pair of the salient poles 32n, 32s, the other end of the S pole common coil 30s is connected to each of the other ends of the N pole induction coil 28n and the S pole induction coil 28s via a lead wire L3 (see also FIG. 5). The lead wire L3 is also provided on the same coil end 29 side as the lead wires L1, 2. The lead wire L3 is configured such that three branched wires thereof respectively connected to the coil ends are drawn to the inner diameter side and are connected to a circumferential jumper wire that is arranged in the circular area 110.

Furthermore, in the above pair of the salient poles 32n, 32s, the one end of the N pole induction coil 28n is connected to the terminal wire T1 of the diode element 41 via a lead wire L4, and the one end of the S pole induction coil 28s is connected to the terminal wire T3 of the diode element 41 via a lead wire L5 (see also FIG. 5). The lead wires L4,5 are also provided on the same coil end 29 side as the lead wires L1 to 13. Each of the lead wires L4, L5 is drawn from each of the one ends of the N pole induction coil 28n and the S pole induction coil 28s to the circular area 110 on the inner diameter side, is drawn in the axial direction as shown in FIG. 10A and FIG. 12, passes through the opening 95 of the end plate 26a, and is connected to the terminal wire T2.

As described above, the leads wires L1, L3 that connects the coil ends with each other, and the lead wires L2, L4, L5 that connect the coil ends to the terminal wires T1, T2, T3 of the diode element 41 are drawn to the circular area 110 positioned near a center of rotation of the shaft 25, and then either extend across the circumferential direction or extend in the axial direction to be connected to the terminal wires T1, T2, T3 of the diode element 41. In each of the lead wires L1 to L5, even when the centrifugal force that is generated by the rotation of the rotor 14 acts on a portion that extends in the radial direction, the portion can withstand the force due to strength in a longitudinal direction of the lead wire and thus is less likely to be deformed. In each of the lead wires L1 to L5, since a portion that extends across the circular area 110 in the circumferential direction or a portion that extends in the axial direction is positioned near the center of rotation, a magnitude of the centrifugal force that acts thereon clue to the rotation of the rotor 14 can be suppressed to be small, and consequently, the deformation due to the centrifugal force is less likely to occur. Accordingly, just as described, since the deformation of each of the lead wires L1 to L5 by the centrifugal force can be suppressed, it is possible to suppress occurrence of peeling or the like of connected portions between the coil ends and the terminal wires T1 to T3 of the diode element 41. In addition, since the lead wires L1 to L5 are arranged to be consolidated as much as possible in an inner space in the radial direction of the coil end 29 (see FIG. 12) that protrudes to the outside in the axial direction from the end surface of the rotor core 24, advantages can be obtained that an axial length of the rotor 14 can be reduced and that the size of the rotary electric machine 10 can thereby be reduced.

In addition, as shown in FIG. 10A, the lead wires L2, L4, L5 are drawn to the inner diameter side of the main body 41a of the diode element 41 in regard to the radial direction of the rotor core 24 in this embodiment. More specifically, the lead wires L2, L4, L5 extend in the axial direction in the circular area 110 described above, pass through the opening 95 of the end plate 26a, and protrude to the outside in the axial direction. Then, each end of the ends of the lead wires L2, L4, L5 is respectively connected at one of three connecting sections 112 to the terminal wires T1, T2, T3 that protrude to the inside in the radial direction from the main body 41a of the diode element 41. In other words, the connecting sections 112 between the terminal wires T1, T2, T3 of the diode element 41 and the lead wires L2, L4, L5 are provided on the inner diameter side of the main body 41a of the diode element 41. However, the connecting section 112 may not necessarily be positioned on the inner diameter side of the main body 41a, but may be positioned to overlap with the main body 41a in the radial direction. In this case, the connecting section 112 only needs to be positioned at least on the inner diameter side of the center in the radial direction of the main body 41a.

The connecting sections 112 make connections in such a manner that the terminal wires T1, T2, T3 and the lead wires L2, L4, L5 are respectively welded, soldered, caulked, or the like, for example, in a line contact state or a surface contact state. Since the connecting sections 112 make the connections in the line contact state or the surface contact state, just as described, connection strength thereof increases, and thus occurrence of defects such as contact failure, peeling by the centrifugal force, and the like can be suppressed.

In addition, the connecting section 112 is formed to extend along a non-parallel direction to the shaft 25. More specifically, in this embodiment, the connecting section 112 extends in a direction to form an angle of approximately 45 degrees, for example, with respect to the axial direction. Since the connecting section 112 is directed non-parallel to the shaft 26, the centrifugal force during the rotation of the rotor is dispersed in a wire direction of the terminal wires and the lead wires that constitute the connecting section 112, and the occurrence of the defect such as peeling of the connecting section 112 can be suppressed by the dispersion.

Furthermore, as will be described below with reference to FIG. 18, the connecting section 112 may integrally be fixed to the end plate 26a, that is, to the shaft 25 by using the resin mold, an adhesive, an adhesive tape, a fixing member, or the like. In such a configuration, even when the connecting section 112 is integrally fixed to the shaft 25 and thereby vibrates, the occurrence of the defect such as peeling in the connecting section 112 can be suppressed.

As described above, according to the rotary electric machine 10 that includes the rotor 14 and this of this embodiment, since the connecting sections 112 between the lead wires L2, L4, L5 and the terminal wires T1, T2, T3 make the connections on the inner diameter side of the diode main body 41a, it is possible to suppress the large centrifugal force that is generated by the high-speed rotation of the rotor 14 from acting on the connecting sections 12, and consequently, it is possible to suppress occurrence of the defects such as peeling of the connecting section 112 and the like caused by the centrifugal force.

In the above, the terminal wires T1, T2, T3 that protrude to the inner diameter side of the diode element 41 and the lead wires L2, L4, L5 that are connected to the coil ends are respectively connected on the outside in the axial direction of the end wall section 92 of the end plate 26a, so as to constitute the three connecting sections 112. However, the configuration is not limited thereto, and, as shown in FIG. 10B, the terminal wires T1, T2, T3 of the diode element 41 may be inserted from the opening 95 of the end wall section 92 to the coil ends, and may be respectively connected to the lead wires L2, L4, L5 on the inside in the axial direction of the end plate 26a to constitute the connecting sections 112.

In addition, as shown in FIG. 10C, the terminal section 41b of the diode element 41 may be formed in a recessed shape on the inside of the diode main body 41a, and the end of each of the lead wires L2, L4, L5 may be inserted in the recessed terminal section 41b, so as to be electrically connected to the diode element 41. Also, in this case, the connecting sections between the recessed terminal section 41b and the lead wires L2, L4, L5 overlap with the main body 41a in regard to the radial direction, but only need to be positioned at least on the inner diameter side of the center in the radial direction of the main body 41a.

Furthermore, as shown in FIG. 10D, the diode element 41 may be arranged in such a direction or a posture that the terminal wires T1, T2, T3 protrude to the outer diameter side from the diode main body 41a, and each of the terminal wires T1, T2, T3 may be folded back to extend to the inner diameter side and connected to each of the lead wires L2, L4, L5 on the inner diameter side of the diode main body 41a, thereby forming the connecting sections 112. Accordingly, the connecting sections 112 are also arranged on the inner diameter side of the diode main body 41a, and the occurrence of the defect such as the peeling of the connecting section can be reduced by suppression of the centrifugal force.

Next, cooling of the diode element 41 that is provided in the rotor 14 will be described with reference to FIG. 13 in addition to FIGS. 9, 10A. FIG. 13 is a cross-sectional view taken along the line D-D in FIG. 9.

A refrigerant flow passage 89 that extends in the axial direction is formed in the shaft 25. A cooling oil, as an example of liquid refrigerants, is circulated and supplied to the refrigerant flow passage 89 via an oil pump, an oil cooler, and the like. Here, the liquid refrigerant is not limited to the cooling oil but may be any liquid other than the cooling oil as far as the liquid has the electric insulating property.

Referring to FIG. 9 and FIG. 13, plural refrigerant discharge ports 98 are formed through the end wall section 92 of the end plate 26a. The refrigerant discharge port 98 is formed in a position that is between the diode elements 41 and near the inner diameter in regard to the circumferential direction. Since the refrigerant discharge port 98 is formed in such a position, as will be described below, the cooling oil that is discharged from the refrigerant discharge port 98 spreads in a substantially fan shape that is illustrated as a stipple area in the drawing and flows to the outside in the radial direction by the centrifugal force of the rotating rotor 14, but does not make direct contact with the diode element 41. Accordingly, there is no occurrence of a defect such as wear caused by contact or collision of the cooling oil, which flows to the outside in the radial direction at a high speed due to the centrifugal force, with the diode element 41.

As shown in FIG. 13, in the shaft 25, plural refrigerant supply passages (first refrigerant supply passages) 96 are formed at intervals in the circumferential direction and extend in the radial direction. The refrigerant supply passage 96 is a passage to supply the cooling oil flowing through the refrigerant flow passage 89 in the shaft to the outside of the shaft. An outer end of the refrigerant supply passage 96 is formed with a counterbore on the surface of the shaft 25 and thus is widened, thereby facilitating alignment with another refrigerant supply passage (second refrigerant supply passage) 97 that is formed in the end plate 26a.

The other refrigerant supply passage 97 that communicates with the refrigerant supply passage 96 of the shaft 25 is formed through the end plate 26a. Then, the refrigerant supply passage 97 is linked to the refrigerant discharge port 98 that is opened to the end wall section 92. In other words, an end of the refrigerant supply passage 97 that is opened to the end wail section 92 itself serves as the refrigerant discharge port 98.

As shown in FIG. 10A and FIG. 13, the end plate 26a may be provided with a cover member 100 for covering at least an outer peripheral portion of the outer recess section 91. This cover member 100 can preferably be configured by a circular plate. A refrigerant discharge hole 102 is formed on an outer periphery of the cover member 100. The refrigerant discharge hole 102 is a spatial area between the cover member 100 and the end plate 26a and has a function to determine an amount of the cooling oil that is reserved in a refrigerant reservoir 103 positioned on the outside in the radial direction.

More specifically, if the refrigerant discharge hole 102 is formed on the further outer diameter side, the amount of the oil reserved in the refrigerant reservoir 103 is reduced, and if the refrigerant discharge hole 102 is formed on the further inner diameter side, the amount of the oil reserved in the refrigerant reservoir 103 is increased. Accordingly, a forming position, size, a shape, and the like of the refrigerant discharge hole 102 may appropriately be set, so as to achieve favorable cooling performance with an amount of the cooling oil that flows out the refrigerant discharge port 95 of and flows to the outside in the radial direction by the action of the centrifugal force being a desired amount.

In addition, the cover member 100 also has a function to suppress misting of the cooling oil that flows out of the refrigerant discharge port 95. More specifically, the refrigerant discharge port 98 is formed in a secluded position on the inside in the axial direction from the axial end surface of the end plate 26a (that is, a bottom of the outer recess section 91 or a position near the bottom), and the cover member 100 is provided to substantially cover the outer recess section 91 of the end plate 26a. Accordingly, it is possible to suppress exposure of the refrigerant discharge port 98 to the surrounding air at a high-speed due to the rotation of the rotor 14, and consequently, the cooling oil can reliably flow along the surface of the end wall section 92 of the end plate 26a to the outside in the radial direction while maintaining a liquid state thereof.

In the rotary electric machine 10 that includes the rotor 14, for which an axis oil cooling structure as described above is adopted, when the cooling oil is supplied to the refrigerant flow passage 89 in the shaft 25 that is positioned on the inside in the radial direction with respect to the diode element 41 attached to the rotor 14, the cooling oil that is then supplied to the outside of the shaft via the refrigerant supply passages 96, 97 flows out of the refrigerant discharge port 98 by the centrifugal force and also by a hydraulic pressure if the cooling oil is pressure fed. Then, the cooling oil that is discharged from the refrigerant discharge port 98 follows the substantially fan-shaped surface area of the end wall section 92 that is positioned between the diode elements 41, extends across the circumferential direction, and flows to the outside in the radial direction.

Meanwhile, the diode element 41 that includes the first and second diodes 38, 40 generates heat when an induced current generated by the induction coils 28n, 28s flows therethrough. The thus-generated heat is transferred from a ventral surface of the diode element 41 (that is, a contact surface with a bottom surface of the attachment groove 94) to the end plate 26a, and is taken by the cooling oil that flows on the outer surface of the end wall section 92 as described above. In other words, the diode element 41 is indirectly cooled by the cooling oil via the end plate 26a.

In addition, in the end plate 26a of this embodiment, the outer surface of the end wall section 92 that is continuous with the refrigerant discharge port 98 is inclined to the radial direction such that it is positioned further on the outside in the axial direction as it approaches the outside in the radial direction. Accordingly, when the cooling oil that flows out of the refrigerant discharge port 98 flows along the outer surface of the end wall section 92, a pressing force on the outer surface that is a component force of the centrifugal force of the rotating rotor acts on the cooling oil. Due to action of such a pressing force, the cooling oil is not turned into mist but maintains the liquid state, and can flow along the outer surface of the end wall section 92 to the outside in the radial direction. Consequently, the sufficient cooling performance for the diode element 41 can be obtained.

The cooling oil that flows along the outer surface of the end wall section 92 to the outside in the radial direction is temporarily reserved in the refrigerant reservoir 103. While being reserved, the cooling oil takes out the heat from the end plate 26a to indirectly cool the diode element 41. Then, the cooling oil that overflows from the refrigerant reservoir 103 is discharged from the refrigerant discharge hole 102 to the outside of the rotor 14. The cooling oil is thereafter removed from a bottom of a case for housing the rotary electric machine 10 and passes through the oil cooler to radiate the heat and reduce a temperature thereof before being circulated and supplied to the refrigerant flow passage 89 in the shaft 25 by an action of the oil pump, and the like.

As described above, the cooling oil that is supplied from the refrigerant flow passage 89 in the shaft 25 that is positioned on the inside in the radial direction with respect to the diode element 41 attached to the end plate 26a is discharged from the refrigerant discharge port 98 of the end plate 26a via the refrigerant supply passages 96, 97 by the centrifugal force of the rotating rotor 14 and the like, flows along the outer surface of the end wall section 92 of the end plate 26 to the outside in the radial direction, and is then supplied to the periphery of the diode element 41. Accordingly, the diode element 41 that generates the heat by energization can be cooled sufficiently via the end plate 26a having favorable thermal conductivity.

In addition, in this embodiment, since the cooling oil is supplied in the area between the diode elements 41 in regard to the circumferential direction, the diode element 41 can be provided on the further inner diameter side when compared to a case where the refrigerant discharge port 98 is formed on the inner diameter side of the diode element 41. Thus, it is possible to suppress the centrifugal force that acts on the diode element 41 (that is, the first and second diodes 38, 40) by the rotation of the rotor 14, and it is also possible to achieve a reduction in weight of a support section (corresponding to the abutment wall section 93 in this embodiment) that resists against the centrifugal force by being abutted against the diode in the radially outside position as well as to achieve suppression of failure in the electronic device.

The cooling structure of the diode element that is provided in the rotor is not limited to what has been described above, and various modifications can be made thereto.

FIG. 14 is a view that corresponds to FIG. 13 and shows another example in which the refrigerant discharge port is formed in the shaft. As shown in FIG. 14, the refrigerant discharge port 98 as the end of the refrigerant supply passage 96 may be formed in a position that is opened to the surface of the shaft 25. Accordingly, the cooling oil that is discharged from the refrigerant discharge port 98 can directly be supplied to the outer surface of the end wall section 92 of the end plate 26a (that is, without intervening the refrigerant supply passage in the end plate), and thus an advantage can be obtained that work and processing cost for providing the refrigerant supply passage and the refrigerant discharge port in the end plate can be saved. In this case, it is preferred that the refrigerant discharge port 98 and the bottom of the outer recess section 91 of the end plate 26a are substantially flat, so as to allow the cooling oil that flows out of the refrigerant discharge port 98 on the shaft 25 to flow out smoothly without being spattered.

FIG. 15 is a view that corresponds to FIG. 13 and shows yet another example in which the refrigerant discharge port is provided on the outside of the rotor. In this example, the cooling oil is supplied from the outside of the rotor 14 to the inside of the outer recess section 91 of the end plate 26a. More specifically, a refrigerant supply pipe 99 that extends from a non-rotational section of the case (not shown) for housing the rotary electric machine 10 or the like is provided near the end plate 26a of the rotor 14, and the cooling oil is injected from the refrigerant discharge port 98 at a tip of the refrigerant supply pipe 99 and is supplied to the outer recess section 91 of the end plate 26a. A position to supply the cooling oil to the end plate 26a in this case is preferably on the inner diameter side from the diode element 41 that is attached to the end plate 26a. Accordingly, the cooling oil that is supplied from the outside of the rotor to the end plate 26a flows to the outside in the radial direction by the action of the centrifugal force, and thus can favorably cool the diode element 41 via the end plate 26a. Also, in this case, since the cooling oil does not have to be supplied from the shaft 25, an advantage can be obtained that the work and the processing cost for forming the refrigerant flow passage, the refrigerant supply passage, the refrigerant discharge port, and the like in the shaft 25 can be saved.

FIG. 16 is a view that corresponds to FIG. 13 and shows further another example in which a refrigerant passage is formed in the end plate 26a. FIG. 17 is a cross-sectional view that is taken along the line E-E in FIG, 16. Here, the cover member is not provided on the end surface of the end plate 26a.

In this example, a refrigerant passage 104 is formed to extend in the end wall section 92 of the end plate 26a. A radially inner end of the refrigerant passage 104 communicates with the refrigerant supply passage 96 that is formed in the shaft 25. In addition, a radially outer end of the refrigerant passage 104 is opened to the outer peripheral surface of the end plate 26a to constitute the refrigerant discharge port 98. Accordingly, the refrigerant passage 104 that is formed in the end plate 26a is provided between the diode element 41 that is provided on the outer surface of the end wall section 92 and the coils 28n, 28s, 30n, 30s that face an inner surface of the end wall section 92 in regard to the axial direction.

Since the refrigerant passage 104 is provided between the diode element 41 and the coils 28n, 28s, 30n, 30s as described above, both of the diode element 41 and each of the coils 28n, 28s, 30n, 30s can be cooled by the cooling oil that is supplied from the refrigerant flow passage 89 and the refrigerant supply passage 96 of the shaft 25 and that flows through the refrigerant passage 104.

More specifically, an amount of heat generation by the coils 28n, 28s, 30n, 30s tends to be larger than an amount of heat generation by the diode element 41, and thus there is a case that the cooling performance of the cooling oil flowing through the refrigerant passage 104 is excessive for the diode element 41. In such a case, since the excess cooling ability is used to cool the coil coils 28n, 28s, 30n, 30s, the cooling performance for the coil coils 28n, 28s, 30n, 30s can also be secured.

In addition, in this example, as shown in FIG. 17, a radiation fin 106 may be formed in a position that is on an inner wall of the refrigerant passage 104 and that corresponds to the diode element 41. With such a configuration, the heat transferred from the diode element 41 via the end wall section 92 can efficiently be radiated from the radiation fin 106 to the cooling oil in the refrigerant passage 104, and thus the cooling performance of the diode element 41 is further improved.

As for the refrigerant passage 104 just as described, the refrigerant passage 104 only has to be provided between the diode element 41 and the coils 28n, 28s, 30n, 30s in regard to the axial direction, and the refrigerant passage 104 may be formed in a position that is dislocated from the diode element 41 in the circumferential direction when seen in the axial direction.

FIG. 18 is a view that corresponds to FIG. 13 and shows an example in which the electronic device is covered with a molding resin and the refrigerant is supplied thereon. Although the cover member 100 is not shown in the drawing, the cover member 100 having a function that is described with reference to FIG. 10A and the like may be provided.

In this example, the diode element 41 that is attached to the end plate 26a is covered with a molding resin section 108. Since the molding resin section 108 is also filled in a periphery of the connecting section between the terminals of the diode element 41 and the ends of the coil coils 28n, 28s, 30n, 30s, the connecting sections 112 between the diode terminals and the coil ends that are connected by welding, caulking, or the like, are prevented from being dislocated and can be fixed together with the shaft 25 in a secure and integral manner. Thus, it is possible to effectively suppress the occurrence of the defect such as peeling of the connecting section 112.

The molding resin section 108 does not have to be provided in a manner to cover the entire outer surface of the end wall section 92, but the molding resin section 108 needs to be formed to at least prevent exposure of the diode element 41 and to have a width that is wide enough to cover the attachment groove 94 for attaching the diode element 41 (see FIG. 9), for example.

With such a configuration, even when the refrigerant discharge port 98 is formed on the shaft 25 that is positioned on the inside in the radial direction of the diode element 41, the cooling oil that is discharged from the refrigerant discharge port 98 flows on the molding resin 108 for covering the diode element 41, and thus the diode element 41 can be cooled sufficiently. In addition, since the cooling oil does not directly contact the main body 41a of the diode element 41, there is no occurrence of the defect such as wear or deterioration that is caused by the contact or collision of the cooling oil that flows to the outside in the radial direction at the high speed against the diode clement 41 by the action of the centrifugal force. Furthermore, similar to the example shown in FIG. 9, since the refrigerant discharge port 98 is formed between the diode elements 41 in regard to the circumferential direction to supply the cooling oil in this example, the diode elements 41 can indirectly he cooled via the end wall section 92, and thus the further improvement in the cooling performance can be expected.

The embodiment of the present invention and the modified embodiments thereof have been described so far. However, the configuration of the rotary electric machine according to the present invention is not limited to that described above, and various modifications and improvements can be made thereto.

For example, it may be configured that the coil ends of the coils 28n, 28s, 30n, 30s that are wound around the rotor core 24 are covered with the molding resin, and the molding resin is substantially filled in the inner recess section 90 of the end plate 26a when the end plate 26a is assembled to the rotor core 24. With such a configuration, the heat transfer from the coils 28n, 28s, 30n, 30s to the end plate 26a can be promoted by intervention of the molding resin that has higher thermal conductivity than the air, and thus the cooling performance of the coils 28n, 28s, 30n, 30s can also be increased. In this case, if the molding resin is filled in the inner recess section 90 via the opening 95 of the end wall section 92 at the same time as the formation of the molding resin section 108 shown in FIG. 18, molding processes can be reduced, and thus man-hours and cost can be reduced.

In addition, in the above embodiment, it is configured that the diode element 41 is attached to the end plate 26a and that the diode element 41 is cooled by the cooling oil supplied from the refrigerant flow passage 89 of the shaft 25; however, the configuration is not limited thereto. For example, it may be configured to cool the diode element, and the coils when necessary, by providing the molding resin section for covering the coils 28n, 28s, 30n, 30s that are wound around the rotor core 24, fixing the diode element on or in the molding resin section, and supplying the liquid refrigerant that is supplied from the shaft or the non-rotating section to the molding resin section.

Furthermore, it has been described above that the diode element as another member is attached to the end plate provided at the end of the rotor core by screwing or the like; however, the present invention is not limited thereto. For example, the diode element that is formed of a semiconductor element may integrally be formed with the end plate or may be mounted in the end plate.

### DESCRIPTION OF THE REFERENCE NUMERALS AND SYMBOLS

10/ROTARY ELECTRIC MACHINE; 12/STATOR; 14, 14a, 14b/ROTOR; 16/STATOR CORE; 18/TEETH; 20u, 20v, 20w/STATOR COIL; 22/SLOT; 24/ROTOR CORE; 25/SHAFT; 26a, 26b/END PLATE; 28n/N POLE INDUCTION COIL; 28s/S POLE INDUCTION COIL; 29/COIL END, 30n/N POLE COMMON COIL; 30s/S POLE COMMON COIL; 32n/N POLE FORMING SALIENT POLE; 32s/S POLE FORMING SALIENT POLE; 33/ROTOR YOKE; 34/SLOT; 36/COMMON COIL PAIR; 38/FIRST DIODE; 40/SECOND DIODE; 41/DIODE ELEMENT; 41A/DIODE MAIN BODY; 41B/TERMINAL SECTION; 42/AUXILIARY SALIENT POLE; 44/FLANGE SECTION; 46/OUTER PROTRUSION SECTION; 89/REFRIGERANT FLOW PASSAGE; 90/INNER RECESS SECTION; 91/OUTER RECESS SECTION; 92/END WALL SECTION; 93/ABUTMENT WALL SECTION; 94/ATTACHMENT GROOVE; 95/OPENING; 96, 97/REFRIGERANT SUPPLY PASSAGE; 98/REFRIGERANT DISCHARGE PORT; 99/REFRIGERANT SUPPLY PIPE; 100/COVER MEMBER; 102/REFRIGERANT DISCHARGE HOLE; 103/REFRIGERANT RESERVOIR; 104/REFRIGERANT PASSAGE; 106/RADIATION FIN; 108/MOLDING RESIN SECTION; 110/CIRCULAR AREA; 112/CONNECTING SECTION; L1, L2, L3, L4, L5/LEAD WIRE; T1, T2, T3/TERMINAL WIRE

1-10. (canceled)

11. A rotor for a rotary electric machine, the rotor comprising:
a shaft that is rotatably supported;
a rotor core that is fixed to the shaft and around which a coil is wound;
an end plate that is arranged at an axial end of the rotor core to rotate together with the rotor core;
an electronic device that has a main body and a terminal section, the main body being provided in an end wall section that is formed to be inclined to an axial direction with respect to a radial direction in the end plate and having a rectifying function, and the terminal section being electrically connected to the main body; and
lead wires that extend from the coil and are connected to the terminal section, are drawn to an inner diameter side of the main body of the electronic device in regard to the radial direction of the rotor core, and are connected to the terminal section of the electronic device.

12. The rotor according to claim 11, further comprising:
a refrigerant discharge port for discharging a liquid refrigerant to the end plate such that the liquid refrigerant flows along an outer surface of the end wall section to the outside in the radial direction by action of a centrifugal force during rotation of the rotor.

13. The rotor according to claim 11, wherein
the terminal section of the electronic device is terminal wires that extend from the main body to the inside in the radial direction, and a connecting section is configured by connecting between the lead wires and the terminal wires on an inner diameter side of the main body of the electronic device.

14. The rotor according to claim 13, wherein
the connecting section between the terminal wires of the electronic device and the lead wires of the coil is connected in a line contact state or a surface contact, and the connecting section is non-parallel to the shaft.

15. The rotor according to claim 12, wherein
the refrigerant discharge port is formed in a position near an inner diameter of the end plate.

16. The rotor according to claim 12, wherein
the refrigerant discharge port is formed to be opened to a surface of the shaft.

17. The rotor according to claim 15, wherein
the plural electronic devices are provided at intervals in a circumferential direction on an axial end surface of the rotor, the refrigerant discharge port for discharging the liquid refrigerant that is supplied from a refrigerant flow passage in the shaft via a refrigerant supply passage is provided between the electronic devices in regard to the circumferential direction, and the refrigerant discharge port discharges the liquid refrigerant supplied from the refrigerant flow passage in the shaft via the refrigerant supply passage.

18. A rotor for a rotary electric machine, the rotor comprising:
a shaft that is rotatably supported;
a rotor core that is fixed to the shaft and around which a coil is wound;
an electronic device that has a main body and a terminal section, the plural electronic devices being provided at intervals in a circumferential direction on an axial end surface of the rotor, the main body being provided non-parallel to the shaft so as to rotate together with the rotor core and having a rectifying function, and the terminal section being electronically connected to the main body;
lead wires that extend from the coil and are connected to the terminal section, are drawn to an inner diameter side of the main body of the electronic device in regard to a radial direction of the rotor core, and are connected to the terminal section of the electronic device; and
a refrigerant discharge port for discharging a liquid refrigerant that is supplied from a refrigerant flow passage in the shaft via a refrigerant supply passage, the refrigerant discharge port being provided between the electronic devices in regard to the circumferential direction.

19. The rotor according to claim 18, wherein
the electronic device is provided in an end plate that constitutes the axial end surface of the rotor, the refrigerant supply passage is configured by a first refrigerant supply passage that is formed in the shaft and a second refrigerant supply passage that is formed in the end plate, and the refrigerant discharge port is formed on a surface of the end plate that is an end of the second refrigerant supply passage.

20. The rotor according to claim 18, wherein
the electronic device is provided in an end plate that constitutes the axial end surface of the rotor, the refrigerant supply passage is formed in the shaft so as to supply the liquid refrigerant from the refrigerant flow passage to the outside of the shaft, and the refrigerant discharge port is formed on a surface of the shaft that is an end of the refrigerant supply passage.

21. The rotor according to claim 18, wherein
the liquid refrigerant that is discharged from the refrigerant discharge port is supplied to a surface of the end plate, and the surface of the end plate is inclined to the outside in an axial direction with respect to the radial direction.
